(19) United States
(12) Patent Application Publication
(10) Pub. No.: US 2006/0148338 A1
(43) Pub. Date: Jul. 6, 2006

(54) Contact element for electrically

(76) Inventor: Florian Virchow, Celle (DE)

Correspondence Address: HEDMAN & COSTIGAN P.C., 1185 AVENUE OF THE AMERICAS, NEW YORK, NY, 10036, US

(21) Appl. No.: 11/248,590

(22) Filed: Oct. 12, 2005

(30) Foreign Application Priority Data
Oct. 13, 2004 (DE) DE 202004015917.1

(51) Int. Cl. H01R 13/11

(52) U.S. Cl. 439/851

(57) ABSTRACT

The object of the invention is a contact element, in particular of ignition voltage parts in internal combustion engines, with an outer sleeve in whose inside an axially acting compression spring is provided.

The invention relates to a contact element, particularly for ignition voltage parts in internal combustion engines, with an outer sleeve inside which is provided an axially acting compression spring.

When internal combustion engines are operated the ignition of the gas content in the cylinders is brought about by means of ignition sparks which are generated by spark plugs. The ignition voltage required for ignition is generated by an ignition device, an ignition coil, via a rigid connection or an ignition cable.

Contact elements which consist of a sleeve incorporating an axially acting compression spring are used for contacting the spark plug and each voltage feed cable. When placed on the spark plug the compression spring is pressed against the spring pressure into the sleeve. This provides good transient contact between the voltage feeds and the spark plug.

The conventional compression spring of the contact element of prior art is founds from spring strip steel and is displaced out of the sleeve with the end directed toward the spark plug. The compression spring consists of spring bronze or copper.

During operation of the internal combustion engine corona phenomena, which result in corrosion, occur due to the high voltages to be transmitted. Because the compression spring escapes from the sleeve and the inlet port to the inside of the sleeve is therefore open, considerable corrosion occurs on the compression spring. The sleeve, with its compression spring, must be regularly replaced.

The object of the invention is to provide a contacting sleeve on which less corrosion takes place.

This object is achieved according to the invention by the use of a contacting sleeve according to claim 1. Preferred embodiments constitute the object of the sub-claims or are described below.

The significant feature of this design is that one of the spring ends rests inside the outer sleeve on a first stop, and the other spring end inside the outer sleeve engages in a cup with which this other spring end is displaceable under the action of the spring as far as a second stop still located inside the outer sleeve.

Therefore the spring does not escape from the outer sleeve because the cup seals the outer sleeve on the outside. For this reason the corona effects cannot affect the parts inside the contact element so easily and cannot cause corrosion so easily, particularly on the spring. The displaceable cups allow an equalisation of tolerances.

According to a further embodiment of the invention provision is made for the second stop for the cup to be provided with another spring end on a bush which is inserted in the outer sleeve. The second stop can therefore be assembled after the spring and cup.

According to a further embodiment of the invention provision is made for the bush and outer sleeve to be connected together by means of a screw connection, particularly on the outside diameter of the sleeve and the inside diameter of the outer sleeve.

According to a further embodiment of the invention provision is made for the bush inside the outer sleeve to be extended so that it guides the compression spring in the outer sleeve. The spring windings preferably rest against the inner walls of the bush.

According to a further embodiment of the invention provision is made for a feed section to connect to the end of the outer sleeve with the first stop, which section exhibits an axial hole about which extends a collar which is enclosed by a spring which, with contact pieces, contacts an ignition voltage feed line in the axial hole through wall openings in the collar. The voltage feed line is well contacted.

According to a further embodiment of the invention provision is made for the parts of the contact element consist of any current conducting material, particularly metal. Here all parts of the contact element preferably consist of material insensitive to corrosion.

All parts of the contact element preferably consist of an alloy steel which is marketed under the commercial name of V2A. This material is insensitive to corrosion. Regular replacement because of possible corrosion phenomena is therefore unnecessary.

According to a further embodiment of the invention provision is made for the outer sleeve to be placed on the end of a spark plug serving for contacting with the end in which the cup is displaceable, and for the other end of the outer sleeve to be connected to an ignition voltage feed line.

For this purpose the outer sleeve can preferably be placed on a spark plug with the end in which the cup is displaceable, so that the contact end of the spar plug penetrates the contact element against the mechanical resistance of the spring, when the cup is displaced, and independently of this for the contact end of the spark plug to be designed at least partially tapered so that the surface areas of the outer conical surfaces of the contact end of the spark plug rest on the correspondingly designed inner cup walls at the bottom of the cup.

Furthermore, the ignition voltage is fed directly via an ignition voltage contact of an ignition coil. The entire area of the ignition voltage supply with the ignition voltage contact and the contact element is preferably surrounded by insulating material, apart from at least the cup contact surface which serves for contacting with the spark plug contact.

According to a further embodiment of the invention provision is made for the ignition voltage to be supplied via a resistance element which is located, for example, in a ceramic cover which is in turn enclosed by a cover of a PTFE-based material, for example, wherein one end of the resistance element is connected to the contact element and the other end of the resistance element is connected to a connecting piece to an ignition cable, which is in turn connected to the ignition coil.

According to a further embodiment of the invention provision is made for the connecting piece to be sealed with the ignition cable and the resistance element by means of an insulating material. Similarly, the contact element can also be sealed at least partially with the resistance element by means of an insulating material.

The sealing compound consists in all cases preferably of a two-component epoxy resin.

The invention is explained further with reference to the drawing, in which:

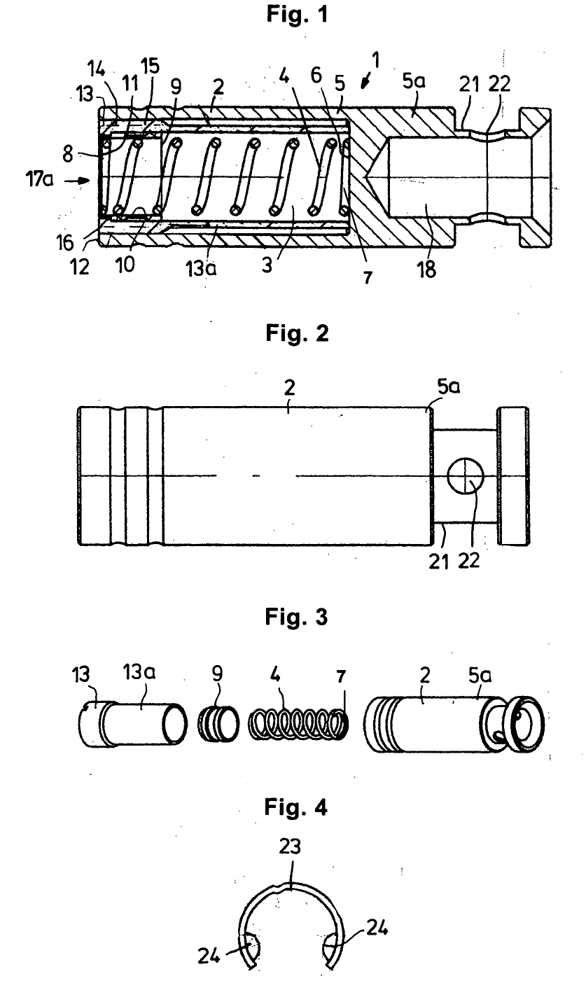

FIG. 1 shows a contacting sleeve according to the invention, in section.

FIG. 2 shows the contacting sleeve according to FIG. 1, in elevation.

FIG. 3 shows the individual parts of the contacting sleeve, in an exploded view,

FIG. 4 shows a side view of the clamping spring used,

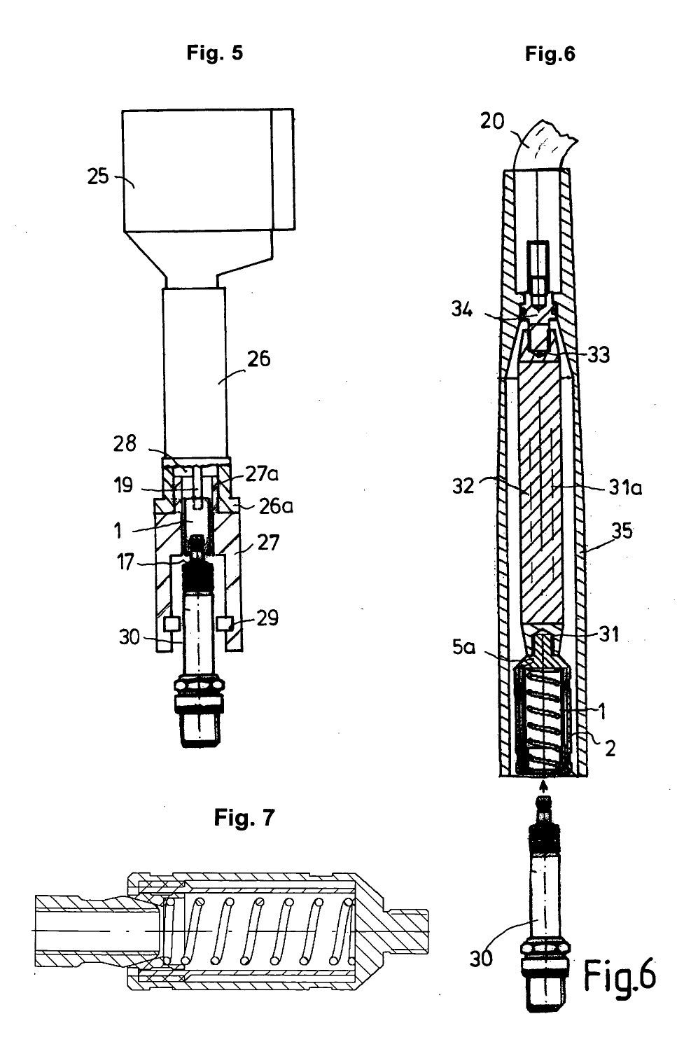

FIG. 5 shows an application of the contacting sleeve with a resistance element and an ignition cable, and

FIG. 5 shows an application connected to a resistance element and an ignition cable, and

FIG. 6 shows the contacting sleeve with immersed spark plug contact.

A contact element 1 shown in FIGS. 1 and 2 serves, for example, to connect a voltage supply to the spark plug. The contact element can of course also be used for other contacting purposes. Examples of contact elements are shown in FIGS. 5 and 6 and are described below.

A compression spring 4 coiled from spring steel wire is located on the inside 3 of an outer sleeve 2 of contact element 1. Outer sleeve 2 passes at one sleeve end 5 into a contact section 5a serving as a supply part. At sleeve end 5 outer sleeve 2 is closed and therefore forms a first stop 6 for compression spring 4. Compression spring 4 rests on this first stop 6 with a spring end 7.

The other spring end 8 is located in a cup 9 with a cup wall 10 and a cup bottom 11. Outer sleeve 2 is open in the region of the other spring end 8 before assembly. Compression spring 4 can therefore be inserted with cup 9 in the inside 3 of outer sleeve 2. After insertion, a bush 13 is inserted in the open end 12 of outer sleeve 2. For this purpose bush 13 is provided on its outside 14 with a thread. Correspondingly the inside 15 of outer sleeve 2 is provided with a thread. The threads are not shown because they are not absolutely necessary, for bush 13 is either screwed into outer sleeve 2 by means of the thread or—if no threads are provided—are glued in.

On its inside bush 13 has a second stop 16. This second stop 16 stops bush 13 in outer sleeve 2 from escaping. Bush 13 can be pushed further into outer sleeve 2 against the action of compression spring 4 when a part, e.g. a spark plug contact 17 (FIG. 5), is pressed in in the direction of an arrow 17a, thus providing good pressure contact. Vibrations and construction tolerances are eliminated.

Bush 13 is provided on the inside 3 of outer sleeve 2 with an extension 13a which is so long that it is able to guide compression spring 4 completely or almost completely over its entire length. Preferably it strikes against the first stop 6 when fully mounted.

Contact section 5a of outer sleeve 2 exhibits an axial hole 18 into which an ignition voltage contact 19 (FIG. 4) or an ignition cable 20 (FIG. 5) can be inserted for ignition voltage supply. Contact section Sa is provided with a collar 21, which exhibits wall openings 22. A connection clamp 23 can be clicked onto collar 21. Contact pieces 24 of connection clamp 23 engage through wall openings 22. An ignition cable inserted in hole 18 or an inserted ignition voltage contact 19 is therefore contacted and retained in a corresponding collar.

FIG. 3 shows the component parts of contact element 1 such as outer sleeve 2 with contact section 5a, compression spring 4, cup 9, bush 13 with extension 13a, in an exploded view. All these parts 2, 5a, 4, 13 and 13a consist of any electrically conducting material. This electrically conducting material may be copper, for example. A material insensitive to corrosion is preferably considered. Preference is given to an alloy steel which is available commercially under the name V2A or V4A. spring clamp 23 also consists preferably of V2A or V4A steel.

FIG. 5 shows one embodiment of contact element 1. An ignition coil 25 exhibits a bar-shaped insulating element 26 through which ignition voltage contact 19 serving to supply the ignition voltage runs axially. An adapter 27, which engages in the inside 28 of insulating element 26, with a support sleeve 27a, is placed on the lower end 26a (in the drawing) of insulating element 26. Adapter 27 preferably consists of silicon and guides contact element 1. A support ring 29 serves to guide a spark plug 30. Spark plug 30, when fully assembled, pushes cup 9 into the inside 3 of outer sleeve 2, thereby generating a higher contact pressure. Contact element 1 is sealed with adapter 27 and ignition voltage contact 19 by means of an insulating compound, preferably by means of a two-component epoxy resin, thus preventing corona effects in this region. Effects triggering oxidation do not influence contact element 1 of V2A steel.

FIG. 6 shows an application of contact element I in which contact element 1 is connected to one end 31 of a resistance denoted by the number 31 a, e.g. an inductive resistance incorporated in a ceramic cover 32. Here the contact section is designed differently from pin 5a. A spark plug 30 is pressed into outer sleeve 2 in the application shown in FIG. 5. The other end 33 of the resistance arranged in ceramic cover 32 is contacted with a metal transition piece 34, to which is connected ignition cable 20 as the ignition voltage supply. The entire arrangement is surrounded by a cover 35 of a PTFE-based material. Ignition cable 20 is sealed with transition piece 34 and ceramic resistance 32 by means of an insulating material. Similarly, contact element 1 is sealed with ceramic resistance 32 by means of an insulating material, apart from the contact face of cup 9. A two-component epoxy resin is preferably used as sealing compound.

FIG. 7 shows how the contact end of a spark plug penetrates the contact element against a mechanical resistance, with displacement of the cup, and how the contact end of the spark plug is designed at least partially tapered so that the surface areas of the conical surfaces of the contact end rest upon the correspondingly shaped inner cup walls at the bottom of the cup.

1. Contact element for the electrical contacting of components, in particular ignition voltage parts in internal combustion engines, with an outer sleeve (2) in whose inside (3) is provided an axially acting compression spring (4) whose one spring end (7) rests upon a first stop (6) inside the outer sleeve (2), and whose other spring end (8) engages inside the outer sleeve (2) in a cup (12) with which this other spring end (8) is displaceable under the action of the compression spring (4) as far as a second stop (16), which is preferably still located inside the outer sleeve (2).

2. Contact element according to claim 1, characterised in that the second stop (16) for the cup (12) is provided with the other spring end (8) on a bush (13) which is inserted in the outer sleeve (2).

3. Contact element according to claim 2, characterised in that the bush (13) and outer sleeve (2) are connected together by means of a screw connection.

4. Contact element according to claim 2, characterised in that the bush (13) inside the outer sleeve (2) is extended so that it guides the compression spring (4) in the outer sleeve (2).

5. Contact element according to one or more of claims 1 to 4, characterised in that a contact section (5a), active as a supply part, is connected to the end (5) of the outer sleeve (2) with the first stop (6), which section exhibits an axial hole (18) about which extends a collar (21) which is surrounded by a preferably removable spring clamp (23) which contacts an ignition voltage supply (19, 20) in the hole (18) with contact pieces (24) through wall openings (22) in the collar (21).

6. Contact element according to one or more of claims 1 to 5, characterised in that the parts of the contact element (1) consist of any electrically conducting material.

7. Contact element according to one or more of claims 1 to 6, characterised in that all parts of the contact element (1) preferably consist of a material insensitive to corrosion.

8. Contact element according to claim 7, characterised in that all parts of the contact element (1) consist of an alloy steel which is marketed, for example, under the commercial name of V2A or V4A.

9. Contact element according to one or more of claims 1 to 8, characterised in that the outer sleeve (2) can be placed on a spark plug (2) with the end (12) in which the cup (13) is displaceable, in that the contact end of the spark plug (30) preferably penetrates the contact element against a mechanical resistance during displacement of the cup (13), and in that, independently of this, the other end (8) of the outer sleeve (2) can be connected too an ignition voltage supply (19, 32).(19,32).

10. Contact element according to one or more of claims 1 to 9, characterised in that the ignition voltage supply takes place directly via an ignition voltage contact (19) of an ignition coil (25).

11. Contact element according to claim 10, characterised in that the entire area of the ignition voltage supply is surrounded, preferably sealed with the ignition voltage contact (19) and the contact element (1), apart from at least the contact face of the cup (6), by means of insulating material.

12. Contact element according to one or more of claims 1 to 9, characterised in that the ignition voltage supply is provided via a resistance element (31) which is located in a cover (32), in particular of ceramic, which is in turn surrounded by a cover (35) of a fluoropolymer, in particular PTFE, based material, wherein one resistance end (31) is connected to the contact element (1) and the other resistance end (33) is connected to a connecting piece (34) to an ignition cable (20).

13. Contact element according to claim 12, characterised in that the connecting piece (34) is surrounded, preferably sealed with the ignition cable (20) and the resistance element (32) by means of an insulating material.

14. Contact element according to claim 12, characterised in that the contact element (1) is sealed with the resistance element (32) by means of an insulating material.

15. Contact element according to claims 11, 13 and 14, characterised in that the sealing compound consists of a two-component epoxy resin.

16. Contact element according to one or more of the preceding claims, characterised in that the element (1) is part of a spark plug socket.

17. Contact element according to one or more of the preceding claims, characterised in that the contact element is surrounded on the outside essentially, apart from the outer conducting contact face of the cup (9), by a fluorinated polymer material, in particular PTFE.

18. Spark plug cover exhibiting the contact element (1) according to one or more of the preceding claims, wherein the spark plug attachment is preferably arranged on the spark plug shank.

19. Spark plug cover according to claim 18, characterised in that the spark plug cover also exhibits an ignition current guide (20), in which high voltage pulses are guided, and an insulating element, and in that the insulating element is formed at least in the region of contact with the spark plug shank.

21. Spark plug cover according to one or more of claims 18 and 19, characterised in that the spark plug cover exhibits a lower insulating sleeve which surrounds at least the upper section of the spark plug (30) with the spark plug contact, in that the contact element (1) is received for making a contact with the spark plug contact, preferably centrically along the axis of the sleeve, and further in that the insulating sleeve preferably consists of a fluoropolymer material.

22. Spark plug cover according to one or more of claims 18 to 21, characterised in that the spark plug cover exhibits the resistance element (31) according to claims 12 to 14.
